(19) United States
(12) Patent Application Publication
(10) Pub. No.: US 2011/0200420 A1
(43) Pub. Date: Aug. 18, 2011

(54) WAREHOUSE DYNAMIC PICKING SLOTS

(75) Inventors: David S. Driskill, Greenville, SC (US); Steven D. Morrison, Piedmont, SC (US); Richard L. Froehlich, Simpsonville, SC (US)

(73) Assignee: VELOCITI ALLIANCE NORTH AMERICA, INC., Greenville, SC (US)

(21) Appl. No.: 13/029,731

(22) Filed: Feb. 17, 2011

Related U.S. Application Data
(60) Provisional application No. 61/305,307, filed on Feb. 17, 2010.

(51) Int. Cl. B65G 1/02; B65G 1/04; G06F 19/00

(52) U.S. Cl. 414/807; 700/214

(57) ABSTRACT

Inventory management methods are provided. In one embodiment, an inventory management method includes receiving an indication of a received product. Available spaces in a warehouse picking area that can store the received product are determined. The received product is stored to one of the spaces, and the space is later reused to store a different product. In another embodiment, a plurality of available spaces for storing a product in a warehouse picking area is determined. The plurality of available spaces includes spaces that have different shapes. An indication of the available spaces and their locations in the warehouse picking area is provided.

### REFERENCE TO RELATED CASE

The present application is based on and claims the benefit of U.S. provisional patent application Ser. No. 61/305,307, filed Feb. 17, 2010, the content of which is hereby incorporated by reference in its entirety.

### BACKGROUND

Warehouses commonly include a picking area that is used to fulfill customer orders. In some warehouses, picking areas include a number of picking slots. Each picking slot includes a predetermined amount of space for storing products, and each picking slot is assigned one product or stock-keeping unit (“SKU”). The picking slots are filled or replenished with product from a reserve area that stores products after they are received from a receiving dock. A picking system (e.g. a manual or an automatic picking system) obtains products needed for an order by retrieving the products from the picking slots. For instance, a picking system may generate a picking list that instructs an operator of what products are needed for an order, how many of each product is needed, and which picking slots have the needed products. The operator can then use the picking list to find the needed products and complete the order.

### SUMMARY

An aspect of the disclosure relates to inventory management methods. In one embodiment, an inventory management method includes receiving an indication of a received product. Available spaces in a warehouse picking area that can store the received product are determined. The received product is stored to one of the spaces, and the space is later reused to store a different product. In another embodiment, a plurality of available spaces for storing a product is determined. The plurality of available spaces includes spaces that have different shapes. An indication of the available spaces and their locations is provided.

These and various other features and advantages that characterize the claimed embodiments will become apparent upon reading the following detailed description and upon reviewing the associated drawings.

### BRIEF DESCRIPTION OF THE DRAWINGS

FIG. 1 is a block diagram of a warehouse.

FIG. 2 is a block diagram of a row having bays, shelves, and shelf positions.

FIG. 3 is a block diagram of an inventory management system.

FIG. 4 is a flow diagram of a method of storing product to a picking area.

FIG. 5 is a flow diagram of a method of picking product from a picking area.

### DETAILED DESCRIPTION

Embodiments of the present disclosure include warehousing systems and methods that utilize dynamic picking slots. In at least certain embodiments, picking slots are dynamic in that they can have variable sizes and shapes. Picking slots may also be dynamic in that they are not limited to any one particular product (e.g. SKU), and can store a variety of different products. Some advantages of using dynamic picking slots may include increasing the amount of product that can be stored at a warehouse, eliminating or reducing the need for reserve areas, and better utilizing available space in the picking area. For example, in one embodiment, as product is received at a receiving dock, the picking system determines what spaces are available in the picking area that can accommodate the product. The product is then put into one of the available spaces, and the picking system tracks where each product is put. When a particular product is needed, the picking system knows where in the picking area the product is located and is able to retrieve it. For instance, a picking system may generate a pick-list that informs an operator of where the needed product is located, and the operator can then go to that location to pick the product. Accordingly, with the use of dynamic pick slots, products do not need to be stored in a reserve area, and pick slots do not need to be replenished. Instead, products are directly stored to the picking area as they arrive. As space in the picking area becomes available, it can be reused to accommodate different products and is not limited to only holding one particular product. It should be noted however that embodiments are not limited to any one advantage or feature, and embodiments may include any one or more combination of features or advantages described in this specification or shown in the figures.

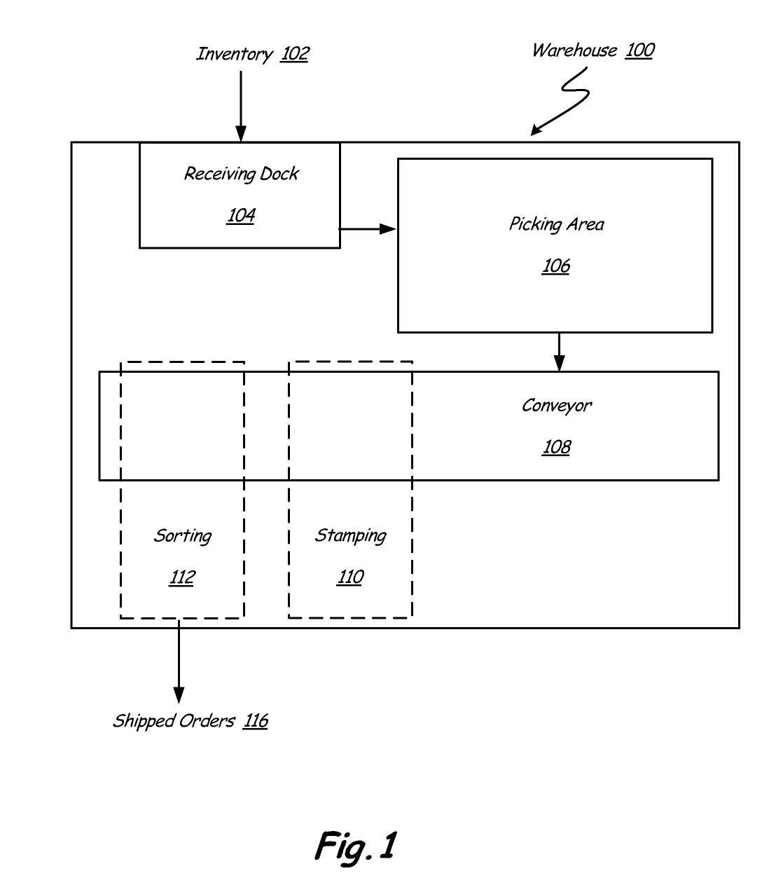

FIG. 1 is a block diagram of one example of a warehouse 100. Embodiments of the present disclosure may be utilized in a warehouse such as warehouse 100. Embodiments are not however limited to any particular setting and may be used in warehouses different than warehouse 100 or in settings other than warehouses. In FIG. 1, inventory 102 is received at a receiving dock 104. Inventory 102 includes a number of different products or stock-keeping units (“SKUs”). In one embodiment, inventory 102 is received on pallets. Each pallet may include a number of cases, and each pallet may include a number of SKUs. For instance, if inventory 102 includes cigarettes, the pallets may include cases of different types of cigarettes. Embodiments of the present disclosure are not however limited to any particular type of product and may include any product or combination of products.

From receiving dock 104, the product is illustratively placed into picking area 106. Some examples of methods used to store product to picking area 106 are described in detail below. However, it is worth highlighting that the product does not need to be put into a reserve area of the warehouse before being placed in picking area 106. Instead, product may be placed directly from receiving dock 104 to picking area 106. Some embodiments may however have a reserve area, and some products could be placed in a reserve area before going to picking area 106.

Product may be stored to picking area 106 in any form or combination of forms. For instance, product may be stored in picking area 106 in pallet form, in full case form, or in broken case form (e.g. cartons or other sub-grouping of products). In one embodiment, products are stored as a combination of full cases and broken cases. For instance, products that move quickly (e.g. high volume products) may be stored as full cases while products that move slower (e.g. lower volume products) may be stored as broken cases. Additionally, any one particular product may be stored in more than one form such as, but not limited to, being stored as both a full case item and as a broken case item.

In one embodiment, such as in the example shown in FIG. 1, product is moved from picking area 106 to a conveyor 108. A picking system illustratively receives orders or batches of orders, and products are transferred from picking area 106 to conveyor 108 in order to fulfill the requirements of the orders or batches of orders. Products may be picked from picking area 106 utilizing any method. For instance, products can be picked manually, by an automated system, or through use of a semi-automated system. For example, a picking system may generate a pick-list for a human operator. The pick-list identifies the locations of the items and how many of each item is needed. The operator can then retrieve the needed items from picking area 106 and place them on conveyor 108. In another example, a picking system uses audio and/or visual signals to direct an operator to a particular picking area location and to inform the operator what quantity of the item is needed. For instance, an LED system can direct an operator to a particular location and inform the operator how many items are needed. Also for instance, an operator may wear a headset and receive audio instructions directing the operator to a particular location and informing the operator how many items are needed. Embodiments are not however limited to any particular method of picking and include any method.

Warehouse 100 may optionally include a stamping unit 110 and/or a sorting unit 112. For instance, if the products in warehouse 100 include cigarettes, stamping unit 110 may be used to apply a tax stamp from a taxing authority. Sorting unit 112 can be used for example to sort batches of orders into particular orders. For example, if items are placed on conveyor 108 in batches and not by individual orders, the items may need to be later sorted into individual orders before shipping. In addition to stamping unit 110 and sorting unit 112, warehouse 100 may optionally include any other processing equipment that may be needed.

Product is next transferred to shipping dock 114 where it is shipped. In an embodiment, products are grouped into orders 116, and the orders 116 are shipped to the customers placing the orders. Orders may be packaged as cases, pallets, totes, or any other form, and shipped to customers by truck. Embodiments of the present disclosure are not however limited to any particular shipping methods and can include any shipping methods.

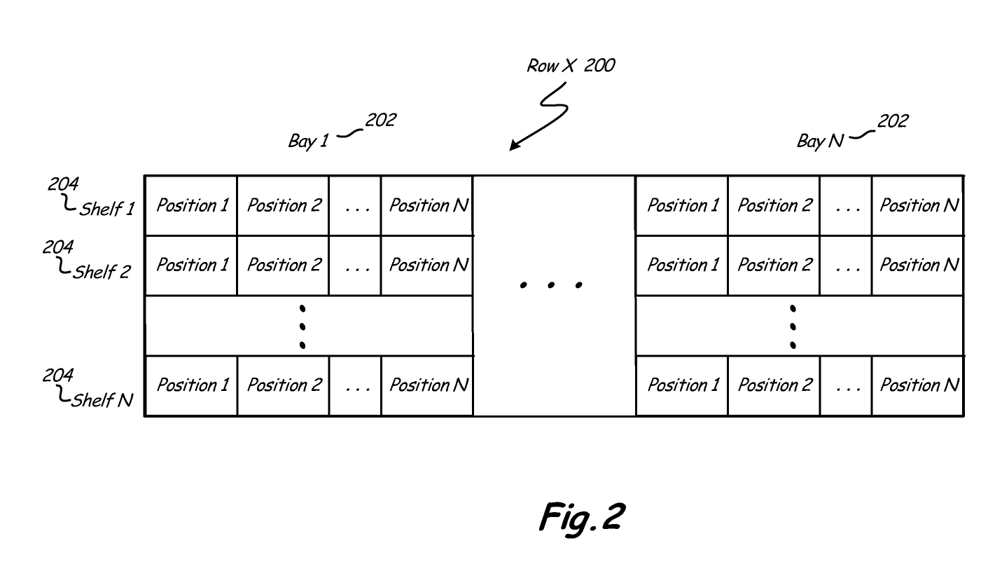

FIG. 2 is a block diagram of one example of a row 200. In an embodiment, a picking area such as picking area 106 in FIG. 1 may include any number of rows 200, and each row is labeled with a unique identifier. For instance, rows can be labeled with letters (e.g. A, B, C, D, etc.), numbers (1, 2, 3, 4, etc.), or a combination of letters and numbers (e.g. A1, A2, B1, B2, etc.). Each row 200 illustratively includes any number of bays 202, and each bay 202 illustratively includes any number of shelves 204. Each bay 202 and each shelf 204 is optionally assigned a label (e.g. a letter, a number, or combination of letters and numbers). Additionally, shelves 204 may be labeled to identify a particular location on the shelf (e.g. position A, B, C, position 1, 2, 3, etc.). Each shelf 204 may include any number of positions. In one particular example, for illustration purposes only and not by limitation, each shelf 204 is 139 inches and is labeled in 5.35 inch increments using the letters A through Z. Embodiments are not however limited to any particular dimensions or methods of labeling.

In an embodiment, every location in a picking area has an assigned label and can be identified/located using the label. For instance, in an embodiment having rows 200, each location can be identified by specifying a row, a bay, a shelf, and a position (e.g. row 10, bay 4, shelf 3, position B). Embodiments are not limited however to any particular labeling or identification scheme and can illustratively include any labeling or identification scheme. The important thing is that unique/specific locations within the picking area can be identified.

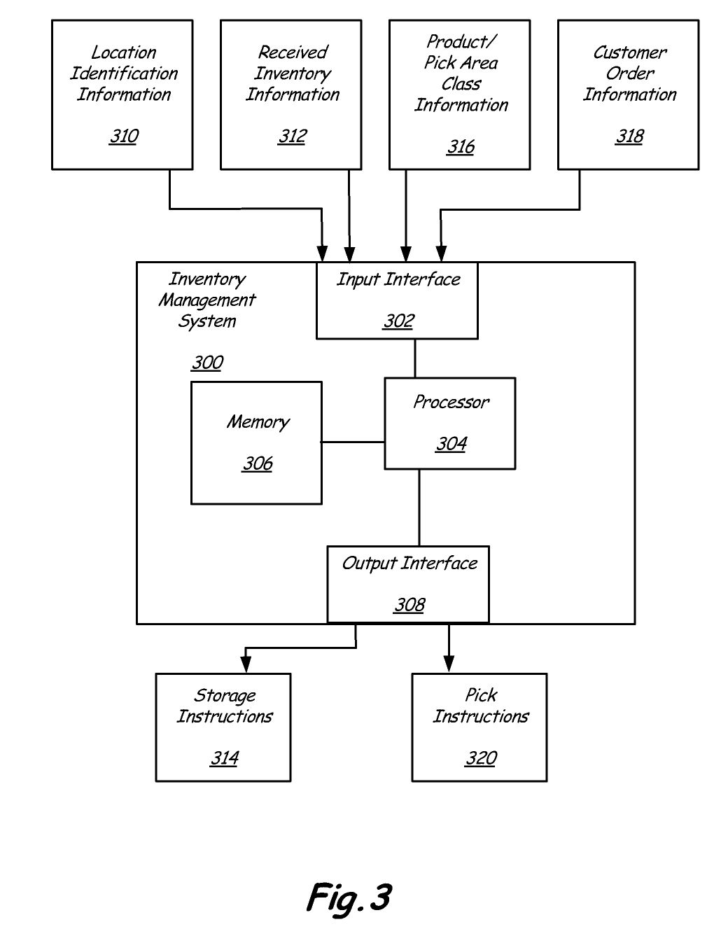

FIG. 3 is a block diagram of an inventory management system 300. System 300 may be implemented utilizing a computing device such as, but not limited to a host computer system (e.g. A/S 400), a personal computer, a server, a laptop, a netbook, a personal digital assistant, a network of personal computers or servers, etc. System 300 illustratively includes an input interface 302, a processor 304, memory 306, and an output interface 308. In an embodiment, input interface 302 receives picking area location identification information 310 and information identifying a type and quantity of the product received 312. Location identification information 310 may include information specifying the labeling or identification scheme for the picking area such as, but not limited to the row, bay, shelf, and shelf position scheme described above. Information 310 may also include information specifying the volume of space or dimensions at each position (e.g. height, width, and/or length of each position). Product information 312 illustratively includes an identifier that uniquely identifies a product (e.g. a SKU or a part number) and a quantity of the product. In an embodiment, memory 306 includes dimensional information for the received products such that processor 304 is able to compute the storage space required for storing the received product.

Based on the picking area information 310 and the product information 312, processor 304 is able to determine what spaces are available in the picking area that are large enough to store the received product. For instance, processor 304 is able to determine what spaces are the exact right size or larger than is needed to store the product. Each of the determined spaces, which may be referred to as slots, can be made up of a number of smaller spaces that are joined together to form one larger space or slot. The spaces that are joined together to form a larger space or slot may be horizontal from each other, vertical from each other, or a combination of horizontally and vertically oriented spaces. The spaces that are grouped together are illustratively adjacent to each other. In an embodiment, the group of spaces or slots are not limited to any particular shape and can have any shape (e.g. rectangular, T-shaped, L-shaped, etc.). For example, in a warehouse picking area having a row, bay, shelf, and shelf position configuration such as that shown in FIG. 2, a slot may include any number of shelf positions along a particular shelf. Accordingly, based on the amount of space that is needed to store a product, the inventory management system can determine what groups of spaces or slots are available in the picking area that can accommodate the product. Additionally, it is worth mentioning that as products are added to or removed from the picking area, the inventory management system tracks what product if any is stored at each location. The inventory management system utilizes that information to determine the available spaces or slots. For instance, new spaces or slots for incoming products become available as products are removed. It is also worth mentioning that the individual sub-spaces that form a larger space or slot are not limited to any particular product, and can be reused for different products.

Once the available spaces or slots are determined, a list or other indication of the spaces/slots is output as storage instructions 314 through output interface 308. Storage instructions 314 illustratively instruct an operator or an automated material handling system where to place the received product. An operator may however optionally not follow storage instruction 314 and may place the received product in a different location in the picking area. Regardless of the storage method, inventory management system 300 receives information indicating where the product was put and stores the information in memory 306. In one embodiment, locations are identified based on the right most space forming the slot, or alternatively could be identified based on the left most space forming the slot. Embodiments are not however limited to any particular method of identifying a space or slot and can include any method.

In one embodiment, inventory management system 300 associates a date-code or time-stamp with the product to indicate when the product was stored and saves that information to memory 306. Inventory management system 300 may use the date-code or time-stamp information to maintain a first-in-first-out (“FIFO”) or other inventory system. For instance, if a picking area already includes a certain type of product and more of the same product is received later, the additional product is put in a new location such that it is not comingled with the product that was stored earlier. One particular product may therefore occupy different spaces or slots within the picking area.

Inventory management system 300 may also receive information indicative of product classes and picking area classes 316 and store the information 316 to memory 306. Each product is illustratively assigned to a class based on how quickly the product moves through the picking area. High volume, quick moving products may for example be assigned to class A. Moderate volume, moderate moving products may be assigned to class B, and the lower volume, slower moving products may be assigned to class C. Product classification is not however limited to any particular scheme.

Each location of the picking area is also illustratively assigned to a class or ranking. In one embodiment, picking area locations that are approximately between the belt height and shoulder height of an operator are the most easily accessed spaces and are reserved for higher volume products. Less centrally located picking area locations are assigned to one or more other classes and are reserved for lower volume products. Embodiments may include any number of picking area classes and use any classification scheme.

In an embodiment, storage instructions 314 are based at least in part on the product class and picking area class information 316. For instance, when a product is received, inventory management system 300 determines the classification that the product belongs to (e.g. by retrieving information from memory 306). Inventory management system 300 also determines the classification of the available storage locations (e.g. by retrieving information from memory 306). The inventory management system 300 then lists or prioritizes the available storage locations based on the class of the product and the classes of the available spaces. For example, a fast moving, high volume product may have spaces between an operator's belt and shoulders listed as the most optimal storage location for the product.

Input interface 302 also illustratively receives order information 318. Order information 318 may include information indicating what products are included in an order and what quantity of each product is needed. Order information 318 may include other information such as information specifying a customer, a delivery date, etc. Multiple orders may be grouped together and processed as a batch. Inventory management system 300 utilizes the order information 318 and information indicating what products are in the picking area and their locations to generate picking instructions 320. Picking instructions 320 illustratively instruct an operator or an automated material handling system which locations of the picking area (e.g. row, bay, shelf, shelf position) include the needed product and how much of the product is needed. Picking instructions 320 may also be based on the time-code or time stamp associated with the stored products. For example, in one embodiment, a FIFO inventory management system or algorithm is used such that if multiple locations of the picking area include the same needed product, the picking instructions 320 prioritize the product with the earliest time-code or time stamp to be picked first. The inventory management system 300 updates its information about what products are in the picking area and their locations to account for the picking or removal of products from the picking area. The information may be manually entered or automatically entered by an automated system. In one embodiment, inventory management system 300 may have an operator verify how much of a product is left when the product is at a certain percentage of its normal inventory (e.g. when the product is at 10% of its normal inventory). Inventory management system 300 may also have an operator verify that all of a product is gone at a particular location before deeming the particular location empty.

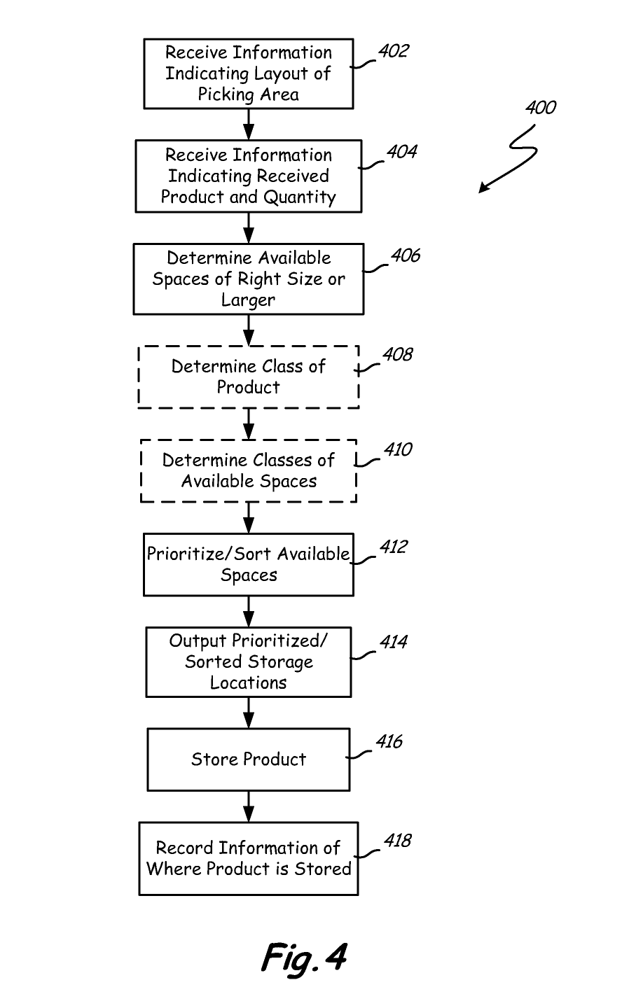

FIG. 4 is a flow diagram of a method 400 of storing product to a picking area. Method 400 is illustratively implemented utilizing an inventory management system such as system 300 in FIG. 3. At block 402, information about a layout of a warehouse picking area is received. The information may include information indicating an identification scheme for the picking area (e.g. row, bay, shelf, position on shelf) and an amount of space available at each location. At block 404, information about products to be stored is received. The information may include information indicating a type of product or SKU and a quantity of the product. At block 406, available spaces (e.g. slots) in the picking area that are either the right size or larger for the product are identified. At block 408, a class of the product is identified (e.g. quick mover, moderate mover, slow mover, etc.). At block 410, classes of the available spaces are identified (e.g. a space between an operator's belt and shoulders may be reserved for quick moving products). At block 412, the available spaces are sorted or prioritized based on the classes of the products and/or the classes of the spaces. At block 414, a sorted or prioritized list of spaces/slots for the product is output (e.g. a pick-list is generated). At block 416, the product is stored to the picking area. The product may be stored to one of the areas in the outputted list, or may alternatively be stored to another location determined by an operator. At block 418, information about where the product is stored is recorded. For example, an operator may input a storage location into an inventory management system that stores the information to its memory.

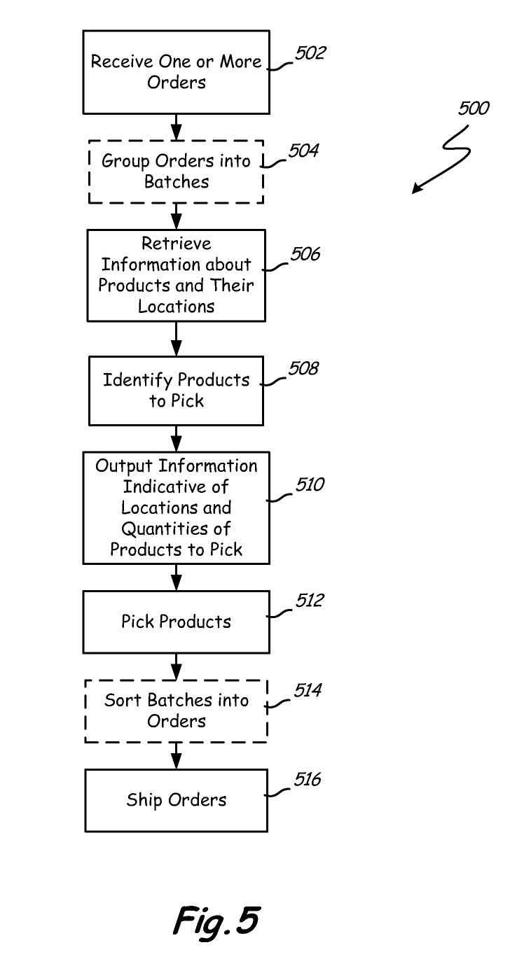

FIG. 5 is a flow diagram of a method 500 of picking product from a picking area. Method 500 is illustratively implemented utilizing an inventory management system such as system 300 in FIG. 3. At block 502, information about one or more orders is received. Each order may include a list of different products or SKUs and a quantity of each product or SKU that is required. At optional block 504, the one or more orders are optionally grouped into batches. At block 506, information about the products and their locations in the picking area is retrieved (e.g. row, bay, shelf, position on shelf). The information may include a time-code or other information indicating when the product was stored. At block 508, the products to be picked are identified. The products that are identified may be chosen based on factors such as, but not limited to maintaining a FIFO inventory system or limiting the amount of movement required by an operator. At block 510, information indicative of the locations of the products to be picked (e.g. row, bay, shelf, position on shelf) and quantities of each of the products to be picked are outputted (e.g. outputted as a pick-list). At block 512, the needed products are picked. At optional block 514, if orders are processed in batches, one or more sorting steps may be utilized to sort the batches back into individual orders. At block 516, orders including the picked products are shipped.

As has been described above and shown in the figures, embodiments of the present disclosure include warehousing systems and methods that utilize dynamic picking slots. Incoming inventory received by a warehouse does not need to be stored in a reserve area and fixed picking slots do not need to be replenished with products. Instead, products are put directly into dynamic slots in the picking area as they are received. The slots are dynamic in that they can have variable sizes and shapes, and are not limited to any one particular product or SKU. An inventory management system illustratively manages the inventory such that when a product is needed, the inventory management can output information indicative of where the product is and how much of the product is needed. As space becomes available in the picking area, it can be reused for a different product or SKU, and may become part of a differently sized or shaped slot than for what the space was previously used for. Some advantages of using dynamic picking slots may include increasing the amount of product that can be stored at a warehouse, eliminating or reducing the need for reserve areas, and better utilizing available space in the picking area. Embodiments are not however limited to any particular one feature or advantage, and may include any one or more combination of features or advantages described in this specification or shown in the figures.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. In addition, although some of the embodiments described herein are directed to particular types of warehouses or picking areas, it will be appreciated by those skilled in the art that the teachings of the disclosure can be applied to other types of inventory management systems, without departing from the scope and spirit of the disclosure.

What is claimed is:

1. An inventory management method comprising:
receiving an indication of a received product;
determining what spaces are available in a warehouse picking area that can store the received product;
storing the received product to one of the spaces; and
reusing the one of the spaces to store a different product.

2. The method of claim 1, wherein the indication of the received product includes a stock-keeping unit and a quantity.

3. The method of claim 1, and further comprising:
prioritizing the spaces based on a class of the received product.

4. The method of claim 1, and further comprising:
prioritizing the spaces based on classes of the spaces.

5. The method of claim 1, wherein the received product and the different product are stored in different forms.

6. The method of claim 5, wherein one of the different forms is a full case form and another one of the different forms is a broken case form.

7. The method of claim 1, and further comprising:
generating output indicative of locations of the spaces.

8. An inventory management method comprising:
determining a plurality of available spaces for storing a product in a warehouse picking area, the plurality of available spaces including spaces that have different shapes; and
outputting an indication of the available spaces that includes information identifying locations of the available spaces in the warehouse picking area.

9. The method of claim 8, wherein the different shapes include shapes that have different horizontal dimensions.

10. The method of claim 8, wherein the different shapes include shapes that have different vertical dimensions.

11. The method of claim 8, and further comprising:
recording information identifying which one of the available spaces is used to store the product.

12. The method of claim 11, and further comprising:
reusing the one of the available spaces to store a different product.

13. The method of claim 11, and further comprising:
reusing the one of the available spaces to store a plurality of different products.

14. An inventory management system comprising:
a memory that stores location information and product information, the location information identifying locations of a warehouse picking area and the product information identifying which one of a plurality of different products is stored at each location in the warehouse picking area, the product information being updated to account for the different products being removed from the warehouse picking area and to account for additional products being added to the warehouse picking area; and
a processor that generates storage instructions, the storage instructions indicating which of the locations of the warehouse picking area can be used to store products as they are received, the storage instructions being based on availability of the locations and not based on any associations of the locations to a particular one of the different products.

15. The system of claim 14, wherein the processor generates picking instructions, the picking instructions identifying one of the locations of the warehouse picking area.

16. The system of claim 15, wherein the picking instructions further identify a product quantity.

17. The system of claim 14, wherein the memory stores product class information.

18. The system of claim 14, wherein the memory stores location class information.

19. The system of claim 14, wherein for a particular one of the different products the processor generates storage instructions that identify locations having different shapes.

20. The system of claim 14, wherein the product information stored by the memory includes information identifying multiple locations of the warehouse picking area as having a same product.
